(19) United States
(12) Patent Application Publication
(10) Pub. No.: US 2005/0098027 A1
(43) Pub. Date: May 12, 2005

(54) Plaited material made of flexible ribbon-shaped or yarn-shaped elements matched with an extensible support

(76) Inventor: Costantino Karazissis Dolzanelli, Vigevano (Pavia) (IT)

Correspondence Address: BUCKNAM AND ARCHER, 1077 NORTHERN BOULEVARD, ROSLYN, NY, 11576, US

(21) Appl. No.: 10/952,049

(22) Filed: Sep. 28, 2004

(30) Foreign Application Priority Data
Oct. 7, 2003 (IT) MI 2003 U 000465

(51) Int. Cl. G03C 5/14

(52) U.S. Cl. 87/2; 87/13

(57) ABSTRACT

A plaited material (10) comprising a plurality of ribbon-shaped or yarn-shaped elements made of leather, hide or synthetic materials matched with and threaded into an elastic or bielastic support (14) formed by a ladderproof mesh web made of natural or synthetic fabric of any shape, size and colour.

The present invention refers to a plaited material made of flexible ribbon-shaped or yarn-shaped elements matched with an extensible support.

More particularly, the present invention refers to a plaited material wherein said ribbon-shaped or yarn-shaped elements are made of leather, hide or other synthetic material and the extensible support is an elastic or a bielastic one, preferably a mesh one.

It is known that, for the manufacturing of various products, especially in the leather industry, plaited materials which are generally made of thin leather stripes of various length are used; the monochromatic or multicolour stripes are interwoven according to an orthogonal or herringbone pattern and form a sort of fabric which is used, for example, to manufacture bags, shoes or parts thereof, clothing, cushions and chair upholsteries or upholstered furniture. These are all fine products, and this peculiarity derives not only from the quality of the raw material which is used, but also from their make and the subsequent aesthetic-chromatic effects.

Anyway it has been noticed that these known materials show a considerable drawback which is due to the fact that the weft obtained cannot be extended. On the contrary, it would be better if these materials could be at least partly extensible, in order to assure a higher comfort to the user of the products manufactured with them, especially as for shoes and cushion upholsteries or upholstered furniture; on the other hand both leather and hide don't show, in their nature, extensibility features.

Object of the present invention is to remove the above-mentioned drawback.

More particularly, object of the present invention is to provide a plaited material constituted by flexible ribbon-shaped or yarn-shaped elements made of leather, hide or synthetic material with high extensibility features in one or more directions.

A further object of the present invention is the provision of a plaited material as defined above wherein said extensibility is regularly reversible, so that the same material can exactly and immediately recover its original configuration when the induced stretching ends.

Another object of the invention: is the provision of an extensible material which can be manufactured in any shape as for surface development in order to produce a semi finished product which is already preformed according to the product or the upholstery to be obtained.

A further object of the invention is to provide the users with a plaited material which can assure a high level of resistance and reliability in time, which can be easily manufactured at low costs.

These and other advantages are obtained by the plaited material made of ribbon-shaped or yarn-shaped elements matched with and threaded into an extensible support of the present invention which is mainly characterized in that it comprises a plurality of ribbon-shaped or yarn-shaped elements, made of leather, hide or synthetic materials which are matched with and threaded into an elastic or a bielastic support formed by a ladderproof mesh web made of natural or synthetic fabric of any shape, size and colour. The manufacturing and functional features of the plaited material made of ribbon-shaped or yarn-shaped elements matched with an extensible support according to present invention will be better understood from the following detailed description wherein reference is made to the attached table of drawing representing a preferred and non-limitative embodiment, wherein:

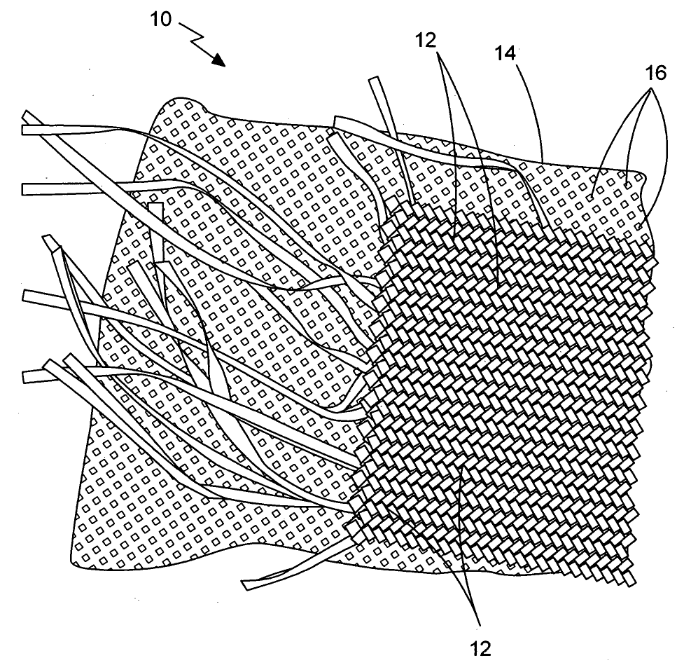

FIG. 1 is a schematic top view of a piece of plaited material according to the present invention.

With reference to the above-mentioned FIGURE, the plaited material of the present invention, marked it its whole with 10, in relation to one of its portion given by way of example as for shape and development, comprises a plurality of stripes 12 made of leather, hide or synthetic material, matched with a support 14; the latter of the known type, is made of an elastic or bielastic ladderproof mesh web of any colour with openings which are separated and sized among them according to any configuration. The stripes 12 of material which is typically but not critically leather, preferably show a minimum width of 1.5 mm and a variable thickness comprised between 0.2 and 3.0 mm; the support 14 said stripes are matched with is made of natural or synthetic material such as silk, nylon or acrylic material.

As can be seen from the attached FIGURE which schematically shows the material of the present invention partially extended in a horizontal direction, the elastic or bielastic support 14 defines many pass-through holes which are close to each other forming the seat for the insertion of one or more stripes 12 overlapping among them along a rectilinear and/or zigzag alternated diagonal direction. The development of the weft: of the stripes 12 compared with the support 14 can be of any kind, it can show a regular or irregular, continuous, or non-continuous development even though the preferred solution is a weft with one or more stripes matched according to a so called herringbone development.

The coupling between the stripes 12 and the support 14 implying the threading and possibly the interweaving of the same stripes along and through many openings 16 of said support, takes place with a manual action or by means of automatic or semi-automatic equipments which are operated by means of mechanical or electromechanical equipments.

As mentioned above, said weft is preferably obtained with a herringbone development, but it is understood that stripes 12 can be matched with the support 14 according to any development. In fact, said stripes 12 can be threaded into non-contiguous openings 16 of the support 14, i.e. leaving one or more openings visible and free in order to obtain, for example, ornamental, geometrical or fancy patterns; the same stripes even grouped among them into more monochromatic or multicolour units according to their width, thickness and/or section can be also threaded into openings 16 according to directions and/or uneven angles. The extensibility of the support 14 which can be an elastic or a bielastic one together with the fact that stripes 12 are easily threaded into it i.e. they are not tight and have a winding development imparts elasticity even to the matched material thus obtained, which after being extended, if required, comes back into its original condition without deforming. With such a material, it is therefore possible to advantageously obtain various manufactured articles according to an innovative method as for shoe, leather, furniture upholstery and clothing industry; the same material can be also used, without linings, as a part of a shoe, for example the leg of a boot. The free end of the stripes or groups of stripes 12 can be fixed into the support 14 with any suitable system, such as knotting, sewing, bonding with adhesives without excluding that the same stripes can be left free and project from said support.

As can be noticed from the previous description, the advantages obtained by the present invention are clear.

The plaited material of the present invention is conveniently made elastic even though the stripes 12 making it are made of leather, hide or synthetic material which are not in their nature extensible; this result is obtained thanks to the use of the elastic or bielastic support 14.

Once produced, this material can be: plated, i.e. pressed in order to even the projection of the stripes 12 from the support 14.

Even though the present invention has been described with reference to one embodiment which is given only by way of non-limitative example, many variants and changes will be clear to people skilled in the art according to the above-mentioned description. Therefore, the invention is meant to include all the changes and variants falling within the spirit and the protective scope of the appended claims.

1. A plaited material (10), characterized in that it comprises a plurality of ribbon-shaped or yarn-shaped elements (12) made of leather, hide or synthetic materials matched with and threaded into an elastic or bielastic support (14) formed by a ladderproof mesh web made of natural or synthetic fabric of any shape, size and colour.

2. The plaited material according to claim 1, characterized in that said ribbon-shaped or yarn-shaped elements (12) are threaded into the holes (16) of the mesh web making the support (14) with a herringbone, rectilinear or crossed development.

3. The plaited material according to claim 1, characterized in that said support (14) of the ribbon-shaped or yarn-shaped elements (12) is shaped according to the product to be obtained.

4. The plaited material according to claim 1, characterized in that said ribbon-shaped or yarn-shaped elements are made of stripes with a width which is not lower than 1.5 mm and a thickness comprised between 0.2 and 3.0 mm.

5. The plaited material according to claim 2, characterized in that the stripes (12) are threaded into non-contiguous openings (16) of the support (14).

6. The plaited material according to claim 2, characterized in that said stripes (12) which are, if necessary, grouped in various monochromatic or multicolour units, are threaded into the openings (16) of the support (14) according to non-continuous directions and angles.

7. The plaited material according to claim 1, characterized in that the free end of the stripes or groups of stripes (12) is fixed into the support (14) by knotting, sewing, bonding with adhesives or the like.

8. The plaited material according to claim 1, characterized in that the end of the stripes or group of stripes (12) threaded into the support (14) is free and projects from the same support.
